(19) United States
(12) Patent Application Publication
(10) Pub. No.: US 2020/0399467 A1
(43) Pub. Date: Dec. 24, 2020

(54) CAMERA LENS RETAINER FOR VEHICLE

(71) Applicant: HYUNDAI MOBIS CO., LTD., Seoul (KR)

(72) Inventors: Hyoung Taek KANG, Yongin-si (KR); Keun Hyung LEE, Yongin-si (KR)

(21) Appl. No.: 16/898,369

(22) Filed: Jun. 10, 2020

(30) Foreign Application Priority Data
Jun. 20, 2019 (KR) 10-2019-0073411

(51) Int. Cl. C08L 77/06; C08L 77/02; G02B 7/02

(52) U.S. Cl. CPC C08L 77/06; C08L 2205/025; G02B 7/021; C08L 77/02

(57) ABSTRACT

The present disclosure relates to a camera lens retainer for a vehicle. In one embodiment, the camera lens retainer for a vehicle is a camera lens retainer for a vehicle in which an inorganic filler is dispersed in a polyamide-based resin matrix, wherein the camera lens retainer includes about 30 wt % to about 60 wt % of a polyamide-based resin and about 40 wt % to about 70 wt % of an inorganic filler, wherein the polyamide-based resin includes one or more of: a first polyamide resin including an aliphatic polyamide resin obtained by ring-opening polymerization of a lactam-based monomer having 8 or more carbon atoms; and a second polyamide resin including an aromatic group-containing polyamide resin obtained by polycondensation of an aromatic dicarboxylic acid monomer and a diamine monomer.

### CROSS-REFERENCE TO RELATED APPLICATION

This application claims priority from and the benefit of Korean Patent Application No. 10-2019-0073411, filed on Jun. 20, 2019, which is hereby incorporated by reference for all purposes as if set forth herein.

### BACKGROUND

### Field

Exemplary embodiments of the present disclosure relate to a camera lens retainer for a vehicle.

### Discussion of the Background

It is very important to form a driving space so that a driver can accurately look at the front, left, right, and rear of a vehicle during driving, and to allow the driver to keep an eye on the adjacent position during parking and stop. To this end, a camera is installed in the interior or rear of the vehicle so that an invisible adjacent position can be sensed by the camera. In particular, the rear camera of the vehicle allows the driver to monitor the blind spot in the rear of the vehicle through a screen, thereby preventing an accident from occurring when the vehicle reverses and ensuring the safety of the occupant.

FIG. 1 illustrates a conventional camera lens module. Referring to FIG. 1, a retainer 10 is an essential component for forming a camera lens module 100 by assembling a lens member 20, which includes a plurality of lenses, spacers, and O-rings, with a barrel 30. The retainer 10 forms a camera exterior and is required to have a watertight function. Meanwhile, the conventional retainer is manufactured from an aluminum alloy material. In addition, in order to ensure corrosion resistance and appearance quality, a method has been used in which the aluminum alloy material is processed into a cylindrical shape, and then surface-treated by anodizing.

However, when the retainer is manufactured from this aluminum alloy material, problems arise in that a process of forming, on the outer circumferential surface of the retainer, a thread for fastening the retainer to the barrel is additionally required, resulting in reduced production efficiency, and in that an oxide layer formed by the anodizing process has poor alkali resistance, and hence the retainer is easily discolored under alkaline conditions. In order to solve these problems, an additional process is required, such as forming a top coating layer or forming a semi-hard film, and hence a problem arises in that the manufacturing cost is increased.

The background art related to the present disclosure is disclosed in Korean Patent Application Laid-Open No. 2017-0119919 (published on Oct. 30, 2017; entitled “Lens and Lens Assembly Including the Same”).

The above information disclosed in this Background section is only for enhancement of understanding of the background of the invention and, therefore, it may contain information that does not constitute prior art.

### SUMMARY

Exemplary embodiments of the present invention provide a camera lens retainer for a vehicle having excellent physical strength, water tightness and dimensional stability.

Another object of the present disclosure is to provide a camera lens retainer for a vehicle having excellent appearance quality, chemical resistance, moisture absorption resistance and weather resistance.

Still another object of the present disclosure is to provide a camera lens retainer for a vehicle having excellent miscibility, fluidity and moldability during the manufacturing thereof.

Yet another object of the present disclosure is to provide a camera lens retainer for a vehicle having excellent productivity, reliability and economic efficiency.

One aspect of the present disclosure is directed to a camera lens retainer for a vehicle. In one embodiment, the camera lens retainer includes about 30 wt % to about 60 wt % of a polyamide-based resin and about 40 wt % to about 70 wt % of an inorganic filler, wherein the polyamide-based resin includes one or more of: a first polyamide resin including an aliphatic polyamide resin obtained by ring-opening polymerization of a lactam-based monomer having 8 or more carbon atoms; and a second polyamide resin including an aromatic group-containing polyamide resin obtained by polycondensation of an aromatic dicarboxylic acid monomer and a diamine monomer.

In one embodiment, the diamine monomer may include an aliphatic diamine having 2 to 12 carbon atoms.

In one embodiment, the first polyamide resin may include one or more of polyamide 12 and polyamide 612, and the second polyamide resin may include polyphthalamide.

In one embodiment, the polyamide resin may include the first polyamide resin and the second polyamide resin at a weight ratio of about 1:0.5 to about 1:5.

In one embodiment, the inorganic filler may include inorganic fiber, and the inorganic fiber may include one or more of glass fiber, carbon fiber, silica fiber, potassium titanate fiber, titanium fiber, aramid fiber, and asbestos fiber.

In one embodiment, the inorganic fiber may have an average diameter of about 3 μm to about 15 μm and an average length of about 0.05 mm to about 5 mm.

In one embodiment, the camera lens retainer may further include, based on the total weight of the camera lens retainer, about 0.01 wt % to about 1 wt % of carbon black.

In one embodiment, the camera lens retainer may have a high-speed surface impact strength of more than about 300 N as measured in accordance with the ISO 6603 standard on a 1-mm-thick specimen at a falling speed of 4.4 m/s, and a linear expansion coefficient (average value in MD (machine direction) and TD (transverse direction)) of about 45 or less in a temperature range from −40° C. to 100° C., as measured in accordance with the ISO 11359 standard.

In one embodiment, the camera lens retainer may have a linear expansion coefficient in MD (machine direction) of about 5 to 20 (×10⁻⁶/° C.) in a temperature range from −40° C. to 100° C. and a linear expansion coefficient in TD (transverse direction) of about 35 to 75 (×10⁻⁶/° C.) in a temperature range from −40° C. to 100° C., as measured in accordance with the ISO 11359 standard.

In one embodiment, the camera lens retainer may have a specific gravity of about 1.2 to 1.9 as measured in accordance with ISO 1183, a flexural strength of about 220 MPa or more as measured in accordance with ISO 178, a flexural modulus of about 14,000 MPa or more as measured in accordance with ISO 178, and a notched impact strength of about 10 kJ/m² or more as measured in accordance with the ISO 179/1eA standard (23° C.) on a 4-mm-thick specimen.

The camera lens retainer for a vehicle according to the present disclosure has excellent physical strength, water tightness and dimensional stability, and also has excellent miscibility, fluidity and moldability during the manufacturing thereof. In addition, the camera lens retainer has excellent appearance quality, chemical resistance, moisture resistance and weather resistance, and also has excellent productivity, reliability and economic efficiency. Thus, the camera lens retainer may be suitable for use as a lens retainer.

It is to be understood that both the foregoing general description and the following detailed description are exemplary and explanatory and are intended to provide further explanation of the inventions as claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a conventional camera lens module for a vehicle.

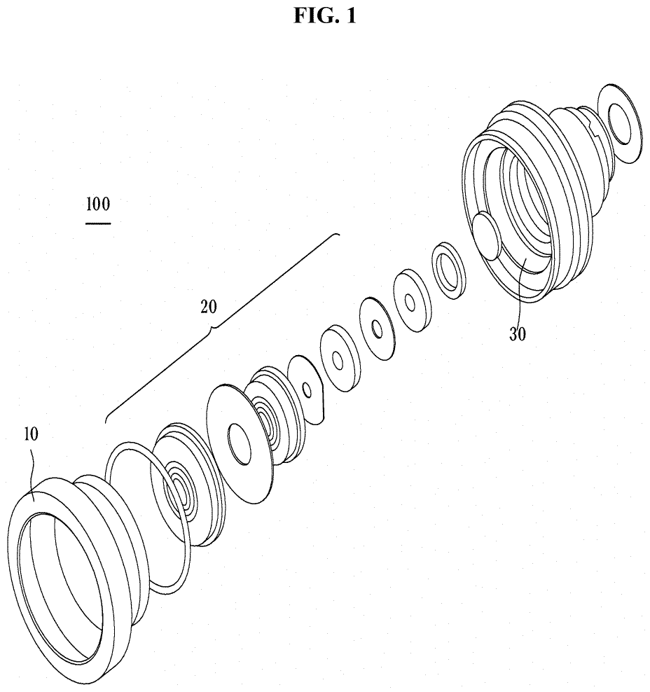

FIG. 2 schematically illustrates a portion of a mold for manufacturing a lens retainer according to one embodiment of the present disclosure.

FIG. 3 is a photograph showing a camera lens module manufactured using a lens retainer of Example 1 of the present disclosure.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

In the following description, the detailed description of related known technology or configurations will be omitted when it may unnecessarily obscure the subject matter of the present disclosure.

In addition, the terms used in the following description are terms defined in consideration of their functions in the present disclosure, may be changed in accordance with the intention of a user or operator or a usual practice. Thus, the definitions of these terms may be made based on the contents throughout the present specification.

Camera Lens Retainer for Vehicle

One aspect of the present disclosure is directed to a camera lens retainer for a vehicle. In one embodiment, an inorganic filler is dispersed in a polyamide-based resin matrix. In one embodiment, the camera lens retainer for a vehicle includes about 30 wt % to about 60 wt % of a polyamide-based resin and about 40 wt % to about 70 wt % of an inorganic filler.

Hereinafter, the constituent components of the camera lens retainer for a vehicle will be described in detail.

Polyamide-Based Resin

The polyamide-based resin includes one or more of: a first polyamide resin including an aliphatic polyamide resin obtained by ring-opening polymerization of a lactam-based monomer having 8 or more carbon atoms; and a second polyamide resin including an aromatic group-containing polyamide resin obtained by polycondensation of an aromatic dicarboxylic acid monomer and a diamine monomer.

The first polyamide resin is obtained by ring-opening polymerization of a lactam-based monomer having 8 or more carbon atoms. When the first polyamide resin is produced using a lactam-based monomer satisfying the above-described carbon number condition, it may have excellent dimensional stability due to reduced moisture absorption rate, and when the first polyamide resin is produced using a lactam-based monomer having less than 8 carbon atoms, the dimensional stability thereof may be reduced as the amide group contained in the polyamide resin absorbs moisture. For example, a lactam-based monomer having 8 to 20 carbon atoms may be used.

For example, the lactam-based monomer may include caprylolactam or laurolactam. For example, the first polyamide resin may include polyamide 12.

The second polyamide resin is obtained by polycondensation of an aromatic dicarboxylic acid monomer and a diamine monomer. In one embodiment, the aromatic dicarboxylic acid monomer may include one or more of isophthalic acid, terephthalic acid, 2,6-naphthoic acid, and 1,5-naphthoic acid.

The diamine monomer may include an aliphatic diamine. In one embodiment, the diamine monomer may include an aliphatic diamine having 2 to 12 carbon atoms. For example, the diamine monomer may include one or more of hexamethylenediamine, 1,11-undecandiamine, 2,2,4-trimethyl-1,6-hexanediamine, 1,12-dodecanediamine, 2-methyl-1,5-pentadiamine, and 1,4-diaminobutanyl. When the diamine monomer satisfying the above-described condition is used, the lens retainer may have excellent dimensional stability against moisture and excellent mechanical strength.

For example, the second polyamide resin may include, as repeating units, a polycondensation polymer of the terephthalic acid or isophthalic acid and the aliphatic diamine. For example, the second polyamide resin may include about 20 mol % to about 80 mol % of aromatic repeating units.

When the second polyamide resin obtained under the above-described conditions is used, it may have excellent dimensional stability against moisture as the amide group contained in the polyamide absorbs moisture, thus preventing the moisture absorption rate of the resin from increasing.

In one embodiment, the second polyamide resin is prepared by polycondensing a mixture including about 20 mol % to about 80 mol % of an aromatic dicarboxylic acid monomer and about 20 mol % to about 80 mol % of a diamine monomer. When the second polyamide resin includes the monomers within the above ranges, it may have excellent mechanical strength and dimensional stability.

In one embodiment, the second polyamide resin may include polyphthalamide.

In one embodiment, the first polyamide resin may include one or more of polyamide 12 and polyamide 612, and the second polyamide resin may include polyphthalamide.

In one embodiment, the polyamide resin may include the first polyamide resin and the second polyamide resin at a weight ratio of about 1:0.5 to about 1:5. When the polyamide resin includes the resins within the above weight ratio range, the lens retainer may have excellent miscibility and dispersability during the manufacturing thereof, and may also have excellent mechanical strength and dimensional stability.

In one embodiment, the polyamide-based resin is included in an amount of about 30 wt % to about 60 wt % based on the total weight of the lens retainer. When the polyamide-based resin is included in an amount of less than about 30 wt %, the moldability, appearance quality and mechanical strengths (such as surface impact strength) of the lens retainer may be deteriorated, and when the polyamide-based resin is included in an amount of more than 60 wt %, the mechanical strengths (such as surface impact strength and flexural strength) and dimensional stability of the lens retainer may be deteriorated. As one example, the polyamide-based resin may be included in an amount of about 35 wt % to about 55 wt %. As another example, the polyamide-based resin may be included in an amount of about 35 wt % to about 45 wt %. For example, the polyamide-based resin may be included in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %.

Inorganic Filler

The inorganic filler may improve the mechanical strength and heat resistance of the lens retainer, and can ensure excellent dimensional stability even under high-temperature conditions.

The inorganic filler may include inorganic fiber. In one embodiment, the inorganic fiber may include one or more of glass fiber, carbon fiber, silica fiber, potassium titanate fiber, titanium fiber, aramid fiber, and asbestos fiber.

In one embodiment, the inorganic filler is included in an amount of about 40 wt % to about 70 wt % based on the total weight of the lens retainer. When the inorganic filler is included in an amount within the above weight range, the lens retainer may have excellent miscibility during the manufacturing thereof and the inorganic filler may have excellent dispersibility. If the inorganic filler is included in an amount of less than about 40 wt %, the dimensional stability against heat and surface impact strength of the lens retainer may be reduced, and thus retainer breakage may occur when high-pressure water is sprayed, and the mechanical strength such as flexural strength is reduced, and if the inorganic filler is included in an amount of more than about 70 wt %, the miscibility and dispersibility of the lens retainer during manufacturing may be reduced and the extrusion moldability and fluidity of the lens retainer during manufacturing may be reduced, and thus a phenomenon may occur in which a thin portion is not molded during manufacturing of the retainer. For example, the inorganic filler may be included in an amount of about 39.99 wt % to about 67 wt % based on the total weight of the lens retainer. For example, the inorganic filler may be included in an amount of about 39.99, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69 or 70 wt %.

In one embodiment, the inorganic fiber may be circular or elliptical in cross section.

In one embodiment, the inorganic fiber may have an average diameter of about 3 μm to about 15 μm and an average length (chop length) of about 0.05 mm to about 5 mm. Under these conditions, the lens retainer may have excellent miscibility and moldability during the manufacturing thereof, and may also have excellent dimensional stability and mechanical strength.

In one embodiment, the inorganic fiber may be included in an amount of about 39.99 wt % to about 67 wt % based on the total weight of the lens retainer. When the inorganic fiber is included in an amount within the above range, the miscibility and dispersibility of the retainer during manufacturing may be excellent, and the mechanical strength and dimensional stability of the lens retainer may be excellent.

In one embodiment, the lens retainer may further include carbon black. The carbon black serves to make the lens container black, unlike the case of a conventional aluminum material which is made by, for example, anodizing. That is, the carbon black may be included for the purpose of making the lens retainer black to prevent light reflection and for the purpose of ensuring quality stability by improving chemical resistance, such as preventing the lens retainer from being discolored by an alkali component.

In one embodiment, the carbon black may be included in an amount of about 0.01 wt % to about 1 wt % based on the total weight of the lens retainer. When the carbon black is included in an amount within the above range, the miscibility and dispersibility of the lens retainer during manufacturing thereof may be excellent, it is possible to ensure excellent blackness and prevent gas generation, and the lens retainer may have excellent mechanical strength and dimensional stability. For example, the carbon black may be included in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 or 1 wt %.

The carbon black may have an average particle diameter of about 0.01 μm to about 50 μm. Under this condition, the lens retainer may have excellent dimensional stability and mechanical strength while having excellent miscibility and moldability during the manufacturing thereof.

In one embodiment, the lens retainer may be manufactured by preparing the above-described components in the above-described amounts, pre-mixing these components using various mixers, melt-kneading the pre-mixture using a Banbury mixer, rolls, a single-screw kneading extruder, a twin-screw kneading extruder and a kneader to obtain a pellet-shaped composition, and then injection-molding the composition. For example, the lens retainer may be manufactured by placing and melt-kneading the constituent components of the lens retainer in a twin-screw extruder, followed by extrusion at an extrusion temperature of about 200° C. to about 330° C. to obtain a pellet-shaped lens retainer composition, and injection-molding of the composition.

In one embodiment, the lens retainer may have a high-speed surface impact strength of more than about 300 N as measured in accordance with the ISO 6603 standard on a 1-mm-thick specimen at a falling speed of 4.4 m/s, and a linear expansion coefficient (average value in MD (machine direction) and TD (transverse direction)) of about 45 or less in a temperature range from −40° C. to 100° C., as measured in accordance with the ISO 11359 standard.

For example, the lens retainer may have a high-speed surface impact strength of about 310 N to about 600 N as measured in accordance with the ISO 6603 standard on a 1-mm-thick specimen at a falling speed of 4.4 m/s, and a linear expansion coefficient (average value in MD and TD) of about 0 to about 40 in a temperature range from −40° C. to 100° C., as measured in accordance with the ISO 11359 standard.

In one embodiment, the lens retainer may have a linear expansion coefficient in MD (machine direction) of about 5 to 20 (×10⁻⁶/° C.) in a temperature range from −40° C. to 100° C., as measured in accordance with the ISO 11359 standard.

In one embodiment, the lens retainer may have a linear expansion coefficient in TD (transverse direction) of about 35 to 75 (×10⁻⁶/° C.) in a temperature range from −40° C. to 100° C., as measured in accordance with the ISO 11359 standard.

In one embodiment, the lens retainer may have a specific gravity of about 1.2 to about 1.9 as measured in accordance with ISO 1183, a flexural strength of about 220 MPa or more as measured in accordance with ISO 178, a flexural modulus of about 14,000 MPa or more as measured in accordance with ISO 178, and a notched impact strength of about 10 kJ/m² or more as measured in accordance with the ISO 179/1eA standard (23° C.) on a 4-mm-thick specimen.

For example, the lens retainer may have a specific gravity of about 1.3 to about 1.8 as measured in accordance with ISO 1183, a flexural strength of about 220 MPa to about 350 MPa as measured in accordance with ISO 178, a flexural modulus of about 14,000 MPa to about 18,000 MPa as measured in accordance with ISO 178, a notched impact strength of about 10 kJ/m² to about 18 kJ/m² as measured in accordance with the ISO 179/1eA standard on a 4-mm-thick specimen under a room temperature condition (23° C.), and a notched impact strength of about 10 kJ/m² to about 17 kJ/m² as measured in accordance with the ISO 179/1eA standard on a 4-mm-thick specimen under a low-temperature condition (−40° C.).

The camera lens retainer for a vehicle according to the present disclosure has excellent physical strength, water tightness and dimensional stability, and also has excellent miscibility, fluidity and moldability during the manufacturing thereof. In addition, the camera lens retainer has excellent appearance quality, chemical resistance, moisture resistance and weather resistance, and also has excellent productivity and economic efficiency. Thus, the camera lens retainer may be suitable for use as a lens retainer.

Hereinafter, the configuration and effects of the present disclosure will be described in more detail with reference to preferred examples. However, these examples are presented as preferred examples of the present disclosure and may not be construed as limiting the scope of the present disclosure in any way. The contents that are not described herein can be sufficiently and technically envisioned by those skilled in the art, and thus the description thereof will be omitted herein.

### EXAMPLES AND COMPARATIVE EXAMPLES

The components used in Examples and Comparative Examples are as follows.

(A1) Polyamide 12 resin produced by ring-opening polymerization of laurolactam was used.

(A2) A mixture of polyphthalamide resins (PA 6I/6T) was used, which includes polyamide 612 resin and an aromatic group-containing polyamide resin, obtained by polycondensation of isophthalic acid and a diamine monomer having 2 to 12 carbon atoms, at a weight ratio of 1:1 to 1:3.

(A3) A resin including polybutylene terephthalate and polyethylene terephthalate was used.

(A4) Polyphenylene sulfide resin was used.

(A5) Polyamide 6 resin was used.

(A6) Polyamide 66 resin was used.

(B) Glass fiber elliptical in cross section was used, which has an average diameter of 3 to 15 μm and an average length (chop length) of 0.05 to 5 mm.

(C) Carbon black having an average particle diameter of 0.01 to 50 μm was used.

### Examples 1 and 2 and Comparative Examples 1 and 5 to 7

The components and contents shown in Table 1 below were mixed together in the amounts shown in Table 1 according to a known method, and then placed and melt-kneaded in a twin-screw kneading extruder, followed by extrusion at an extrusion temperature of 220 to 330° C. to obtain pellet-shaped lens retainer compositions. Next, the pellets were dried, and then injection-molded in an injection molding machine, thereby preparing specimens.

### Comparative Examples 2 to 4

The components and contents shown in Table 1 below were mixed together in the amounts shown in Table 1 according to a known method, and then placed and melt-kneaded in a twin-screw kneading extruder, followed by extrusion at an extrusion temperature of 320 to 340° C. to obtain pellet-shaped lens retainer compositions. Next, the pellets were dried, and then injection-molded in an injection molding machine, thereby preparing specimens.

### Comparative Example 8 and 9

The components and contents shown in Table 1 below were mixed together in the amounts shown in Table 1 according to a publicly-known method, and then placed and melt-kneaded in a twin-screw kneading extruder, followed by extrusion at an extrusion temperature of 250 to 300° C. to obtain pellet-shaped lens retainer compositions. Next, the pellets were dried, and then injection-molded in an injection molding machine, thereby preparing specimens.

TABLE 1

| | Examples | | | | | | |
|---|---|---|---|---|---|---|---|
| Components (wt %) | 1 | | Comparative Examples | | | | |
| (A1) | 34.7 to 34.9 | | | | | | 5 |
| (A2) | — | 4.7 to 34.9 | | | | | |
| (A3) | — | | 0 | | | | |
| (A4) | — | | | 0 | 5 | 0 | |
| (B) | 65 | 5 | 0 | 0 | 0 | 0 | 4.7 |
| (C) | 0.1 to 0.3 | .1 to 0.3 | | | | 0 | .3 |

TABLE 2

| Com- | Comparative | | | |
|---|---|---|---|---|
| ponents | Examples | | | |
| (wt %) | | 7 | | 9 |
| (A1) | 5 | — | | — |
| (A2) | | 25 | | — |
| (A3) | | — | | — |
| (A4) | | — | | — |
| (A5) | | — | 0 | — |
| (A6) | | — | | 40 |
| (B) | 4.7 | 74.7 | 9.8 | 59.8 |
| (C) | .3 | 0.3 | .2 | 0.2 |

Physical Property Evaluation (1)

For Examples 1 and 2 and Comparative Examples 1 to 4 and 8 and 9, which are representative of the Examples and the Comparative Examples, the physical properties were evaluated according to the following methods, and the results of the evaluation are shown in Table 3 below.

(1) Specific gravity was measured in accordance with ISO 1183.

(2) Flexural strength (MPa) and flexural modulus (MPa) were measured in accordance with ISO 178.

(3) Impact strength (KJ/m²): In accordance with the ISO 179/1eA standard, the notched impact strength under a room temperature condition (23° C.) and the notched impact strength under a low-temperature condition (−40° C.) were measured on 4-mm-thick specimens of the Examples and Comparative Examples.

(4) High-speed surface impact test (N): In accordance with the ISO 6603 standard, the high-speed surface impact properties of the 1-mm-thick specimens of the Examples and the Comparative Examples were tested at a falling speed of 4.4 m/s, and the peak force and total energy of each specimen were measured.

(5) Linear expansion coefficient (×10⁻⁶/° C.): In accordance with the ISO 11359 standard, the linear expansion coefficients in TD and MD directions of each specimen in a temperature range from −40 to 100° C. were measured.

TABLE 3

| | | Examples | | | | | | | |
|---|---|---|---|---|---|---|---|---|---|
| Properties | | 1 | | Comparative Examples | | | | | |
| Specific gravity | | 1.7 | .67 | .75 | .42 | .65 | .5 | .57 | .68 |
| Flexural strength (MPa) | | 230 | 30 | 60 | 60 | 57 | 40 | 70 | 50 |
| Flexural modulus (MPa) | | 14660 | 7250 | 5960 | 5410 | 3530 | 450 | 3930 | 6740 |
| Impact | Room | 14.3 | 5.8 | 0 | 0.2 | 0.4 | 2.8 | 0.5 | 0.5 |
| strength | temperature | | | | | | | | |
| (KJ/m²) | (23° C.) | | | | | | | | |
| | Low | 12.8 | 4.8 | 0.6 | 0 | 0.2 | 2.1 | 0.6 | 0.6 |
| | temperature | | | | | | | | |
| | (−40° C.) | | | | | | | | |
| High-speed | Peak Force | 565 | 59 | 00 | 20 | 38 | 62 | 10 | 10 |
| surface | (N) | | | | | | | | |
| impact | Total energy | 3.7 | .9 | .8 | .7 | | .4 | .7 | .7 |
| (1 T) | (J) | | | | | | | | |
| Thermal | MD | 10 | 8 | 4 | 5 | 2 | .1 | 0 | 0 |
| expansion | TD | 70 | 5 | 2 | 1 | 0 | 0 | 6 | 6 |
| coefficient | Average | 40 | 7 | 8 | 8 | 6 | 3 | 8 | 8 |
| (10⁻⁶/° C.) | | | | | | | | | |

Referring to the results in Table 3 above, it could be seen that the specimens of Examples 1 and 2 had excellent flexural strength, impact strength, surface impact properties and dimensional stability. On the other hand, the specimens of Comparative Examples 1 to 4 and 8 and 9, which deviate from the conditions of the present disclosure, had lower flexural strength, impact strength, surface impact properties or dimensional stability than that of Examples 1 and 2.

Physical Property Evaluation (2)

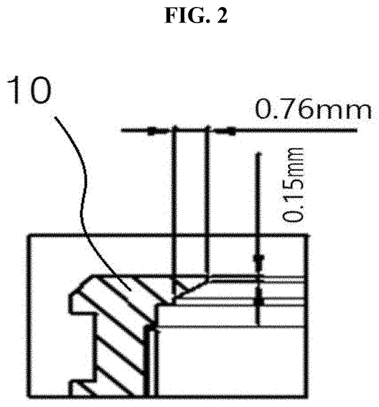

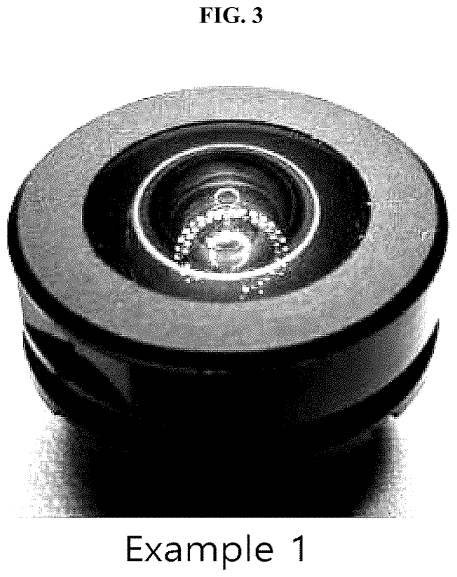

(1) High-pressure water spray test: For the specimens prepared in the Examples and the Comparative Examples, lens retainers were manufactured using a mold shown in FIG. 2. Specifically, each of the lens retainers was machined by a conventional method to form, on the inner circumferential surface of the retainer, a thread for fastening the lens retainer to a barrel, and a thin portion having a thickness of 0.15 mm was formed on the thread. Then, the lens retainer, a plurality of lenses and spacers, and a barrel were fastened together according to a conventional method, thereby manufacturing each camera lens module as shown in FIG. 3. Thereafter, each lens module was placed in a jig, fixed with silicone, and fixed water-tightly to an IR-CUT filter. Then, high-pressure water was sprayed on each of the modules of the Examples and the Comparative Examples under the conditions of water pressure of 170 bar, distance of 30 cm and exposure time of 2 minutes, and retainer breakage or lens deviation was observed centered on the thin portion. The results of the observation are shown in Tables 4 and 5 below.

(2) Temperature cycle test: For the camera lens modules of the Examples and the Comparative Examples, a temperature cycle test was performed in accordance with the MS210-06 standard. Specifically, the specimens of the Examples and the Comparative Examples were heated and subjected to a temperature cycle test for 3 cycles, each consisting of standing at 70 to 100±2° C. for 3 hours→standing at room temperature for 1 hour→standing at −40±2° C. for 3 hours→standing at room temperature for 1 hour→standing at 50±2° C. and 90% relative humidity (RH) or higher for 7 hours or more→standing at room temperature for 1 hour. Next, whether or not specimen discoloration, fading, swelling or cracking occurred, whether or not looseness of a screw joint occurred, or whether or not the requirements of the specimen gap and step were satisfied, was evaluated by visual observation. If discoloration, fading, swelling, cracking or deterioration in gloss did not occur, it was evaluated as OK.

(3) Water resistance test: For the camera lens modules of the Examples and the Comparative Examples, a water resistance test was performed in accordance with the MS210-06 standard. Specifically, each specimen was immersed in hot water at 40±2° C. for 240 hours, and then observation was made on whether or not discoloration, fading, peeling and swelling occurred and whether or not the accessory parts inside the lens module and the inserted parts were rusted. If these phenomena did not occur, it was evaluated as OK.

(4) Impact resistance test: For the specimens of the Examples and the Comparative Examples, an impact resistance test was performed in accordance with the MS210-06 standard. Specifically, after each specimen was mounted on the rear of the vehicle body, an impact resistance test was performed under 23±2° C./−30±2° C. and 10 kg·cm. Then, whether or not significant cracking and breakage of the lens module occurred was observed, and if this phenomenon did not occur, it was evaluated as OK.

(5) Chemical resistance test: For the specimens of the Examples and the Comparative Examples, a chemical resistance test was performed in accordance with the MS210-06 standard. Specifically, diesel oil, gasoline, polished wax, antifreeze solution, engine oil and washer fluid were each applied to each of the specimens of the Examples and the Comparative Examples, and whether or not the cracking, discoloration, fading and swelling of the specimen surfaces occurred was visually observed. If these phenomena did not occur, it was evaluated as OK.

(6) Weather resistance test: For the specimens of the Examples and the Comparative Examples, a weather resistance test was performed in accordance with the MS210-06 standard. Specifically, each specimen was exposed to a total irradiation dose of 2500 KJ/m² at a wavelength of 340 nm, and then the gray scale of each specimen was graded (standard: grade 4 or higher), and evaluation was made on whether or not significant discoloration (color difference (ΔE*): 3.0 or less), fading, swelling, cracking, or deterioration in gloss of the specimen surface occurred or whether there was no abnormality in adhesion.

TABLE 4

| | | | Comparative Examples | | | |
|---|---|---|---|---|---|---|
| Properties | Examples | | 1 | | | 4 |
| High-pressure | OK | OK | Broken | OK | OK | Broken |
| water spray | | | | | | |
| Temperature | K | K | OK | K | K | OK |
| cycle | | | | | | |
| Water | K | K | OK | K | K | OK |
| resistance | | | | | | |
| Impact | K | K | OK | K | K | OK |
| resistance | | | | | | |
| Chemical | K | K | OK | K | K | OK |
| resistance | | | | | | |
| Weather | .2 | .6 | 2.3 | .2 | .1 | 10.5 |
| resistance | | | | | | |
| (ΔE*) | | | | | | |

TABLE 5

| | Comparative Examples | | | | |
|---|---|---|---|---|---|
| Properties | 5 | 6 | 7 | 8 | 9 |
| High-pressure | OK | Broken | Broken | Broken | OK |
| water spray | | | | | |
| Temperature | OK | OK | OK | OK | OK |
| cycle | | | | | |
| Water | OK | NG | NG | OK | OK |
| resistance | | | | | |
| Impact | NG | NG | OK | OK | OK |
| resistance | | | | | |
| Chemical | OK | OK | OK | OK | OK |
| resistance | | | | | |
| Weather | More | More | More | More | More |
| resistance | than 3 | than 3 | than 3 | than 3 | than 3 |
| (ΔE*) | | | | | |

Referring to the results in Tables 4 and 5 above, it could be seen that, in the case of the Examples of the present disclosure, neither breakage of the thin portion of the retainer nor lens deviation after the high-pressure water spray test occurred, and the specimens of the Examples had excellent reliability properties such as heat resistance, water resistance, impact resistance, chemical resistance and weather resistance. On the contrary, it could be seen that, in the case of Comparative Examples 1 to 9, retainer breakage or lens deviation after the high-pressure water spray test occurred, and the reliability, such as whether resistance, of the Comparative Examples was lower than that of Examples 1 and 2.

The present disclosure has been described with reference to the embodiments. Those skilled in the art to which the present disclosure pertains will appreciate that the present disclosure may be embodied in modified forms without departing from the essential characteristics of the present disclosure. Therefore, the embodiments described above are considered to be illustrative, and not restrictive. Furthermore, the scope of the present disclosure is defined by the appended claims rather than the detailed description, and it should be understood that all differences within the scope equivalent thereto are included in the scope of the present disclosure.

What is claimed is:

1. A camera lens retainer for a vehicle, comprising:
about 30 wt % to about 60 wt % of a polyamide-based resin comprising one or more of 1) a first polyamide resin including an aliphatic polyamide resin made by ring-opening polymerization of a lactam-based monomer having 8 or more carbon atoms; and 2) a second polyamide resin including an aromatic group-containing polyamide resin made by polycondensation of an aromatic dicarboxylic acid monomer and a diamine monomer; and
about 40 wt % to about 70 wt % of an inorganic filler,
wherein the weight percent of the polyamide-based resin and inorganic filler is based on a total weight of the camera lens retainer.

2. The camera lens retainer of claim 1, wherein the diamine monomer comprises an aliphatic diamine having 2 to 12 carbon atoms.

3. The camera lens retainer of claim 1, wherein the first polyamide resin comprises one or more of a polyamide 12 and a polyamide 612, and the second polyamide resin comprises polyphthalamide.

4. The camera lens retainer of claim 1, wherein the polyamide resin comprises the first polyamide resin to the second polyamide resin having a weight ratio of about 1:0.5 to about 1:5.

5. The camera lens retainer of claim 1, wherein the inorganic filler comprises an inorganic fiber, comprising one or more of a glass fiber, a carbon fiber, a silica fiber, a potassium titanate fiber, a titanium fiber, an aramid fiber, and an asbestos fiber.

6. The camera lens retainer of claim 5, wherein the inorganic fiber has an average diameter of about 3 μm to about 15 μm and an average length of about 0.05 mm to about 5 mm.

7. The camera lens retainer of claim 1, wherein the camera lens retainer further comprises about 0.01 wt % to about 1 wt % of carbon black based on the total weight of the camera lens retainer.

8. The camera lens retainer of claim 1, wherein the camera lens retainer has a high-speed surface impact strength of more than about 300 N as measured in accordance with ISO 6603 standard on a 1-mm-thick specimen at a falling speed of 4.4 m/s, and a linear expansion coefficient being an average value in the machine direction and the transverse direction of about 45 or less in a temperature range from −40° C. to 100° C., as measured in accordance with the ISO 11359 standard.

9. The camera lens retainer of claim 1, wherein the camera lens retainer has a linear expansion coefficient in the machine direction of about 5×10⁻⁶/° C. to about 20×10⁻⁶/° C. in a temperature range from −40° C. to 100° C. and a linear expansion coefficient in the transverse direction of about 35×10⁻⁶/° C. to about 75×10⁻⁶/° C. in a temperature range from −40° C. to 100° C., as measured in accordance with ISO 11359 standard.

10. The camera lens retainer of claim 1, wherein the camera lens retainer has a specific gravity of about 1.2 to about 1.9 as measured in accordance with ISO 1183, a flexural strength of about 220 MPa or more as measured in accordance with ISO 178, a flexural modulus of about 14,000 MPa or more as measured in accordance with ISO 178, and a notched impact strength of about 10 kJ/m² or more as measured in accordance with ISO 179/1eA standard (23° C.) on a 4-mm-thick specimen.
